(19) United States
(12) Patent Application Publication
(10) Pub. No.: US 2016/0184820 A1
(43) Pub. Date: Jun. 30, 2016

(54) MICROFLUIDIC DEVICE

(71) Applicant: SONY DADC AUSTRIA AG, Salzburg (AT)

(72) Inventors: Gottfried REITER, Adnet (AU); Dario BOROVIC, Hallein (AU); Georg BAUER, Salzburg (AU)

(73) Assignee: Sony DADC AUSTRIA AG, Salzburg (AU)

(21) Appl. No.: 14/911,967

(22) PCT Filed: Jul. 25, 2014
(86) PCT No.: PCT/EP14/66088

§ 371 Date: Feb. 12, 2016

(30) Foreign Application Priority Data
Aug. 14, 2013 (EP) 13180483.3

(51) Int. Cl. B01L 3/00; B29C 65/10; B29C 45/00

(52) U.S. Cl. CPC B01L 3/502707; B01L 3/502715; B29C 45/006; B29C 65/10; B01L 2200/12; B01L 2300/12; B01L 2300/0861; B01L 2300/0627; B01L 2300/0887; B29K 2101/12

(57) ABSTRACT

A microfluidic device comprises a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels, in which one or more bonding formations, separate to the fluid-carrying formations defining the microfluidic channel network, are formed so as to roughen at least one of the bonding surfaces.

### CROSS REFERENCE TO RELATED APPLICATIONS

The present application claims the benefit of the earlier filing date of EP13180483.3, filed at the European Patent Office on 14 Aug. 2013, the entire content of which application is incorporated herein by reference.

### BACKGROUND

1. Field

The present disclosure relates to microfluidic devices and methods of manufacture and inspection of such devices.

2. Description of Related Art

The background description provided here is for the purpose of generally presenting the context of the disclosure. Work of the presently named inventors, to the extent that it is described in the background section, as well as aspects of the description which may not otherwise qualify as prior art at the time of filing, are neither expressly nor implicitly admitted as prior art against the present disclosure.

Microfluidic circuits are typically manufactured as planar structures from two substrates which are bonded together and arranged in a carrier. The carrier is sometimes referred to as a caddy. In the case of polymer substrates, thermal bonding and solvent vapour bonding are example bonding methods. In particular, thermal bonding has advantages for biological applications in that no contaminants are involved, for example in comparison to adhesive bonding. Microfluidic circuit elements, such as channels and mixing chambers, are formed at the interface between the substrates by surface structures in one or both of the substrates.

So, in some arrangements, a closed structure can be created by forming a channel, well or similar open formation in one part or substrate, and bonding a second part (such as another substrate, a rigid polymer part or a thin foil) to cover or close the open formation.

Thermal bonding and solvent vapour bonding rely on first softening one or both of the polymer surfaces to be bonded and then pressing the two surfaces together to induce some deformation. In the case of bonding to cover or close an open formation, the bonding of course takes place around the periphery of the open formation.

At this peripheral region around the functional structures, in an ideal case the surfaces at which bonding is to take place are flat, in order to obtain an even bond. Deviations from flatness can be caused by moulding or formation errors (leading to waviness or unevenness of the surfaces) of burrs (raised edges formed around areas which have been moulded or machined). If such deviations are present, they can interfere with the bonding process, and so interfere with the integrity of the finished article, and in particular can affect the integrity of the closed structure—and in some cases, can cause the closed structure to leak.

### SUMMARY

According to a first aspect of the present disclosure, there is provided a microfluidic device comprising: a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels, in which one or more bonding formation microstructures, separate to the fluid-carrying formations defining the microfluidic channel network, are formed so as to roughen at least one of the bonding surfaces.

Further respective aspects and features are defined by the appended claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates a substrate of a microfluidic device;

FIG. 2 schematically illustrates the substrate of FIG. 1 and a closure member;

FIG. 3 schematically illustrates the substrate of FIG. 1 with the closure member in place;

FIG. 4 schematically illustrates a substrate of a microfluidic device having bonding formations;

FIG. 5 schematically illustrates the substrate of FIG. 4 with a closure member in place;

FIGS. 6-8 schematically illustrated the closure of a substrate having plural openings;

FIGS. 9-13 schematically illustrate different forms of bonding formation;

FIG. 14 is a schematic cross-section of a microfluidic device;

FIG. 15 is a schematic plan view of the microfluidic device of FIG. 14;

FIG. 16 is a schematic flowchart illustrating steps in the production of a substrate;

FIGS. 17 and 18 are respective alternative flowcharts showing steps in the production of bonding formations on a substrate;

FIG. 19 schematically illustrates a chamber for solvent activation;

FIG. 20 schematically illustrates the chamber of FIG. 19 in use;

FIG. 21 schematically illustrates a microfluidic apparatus;

FIG. 22 is a schematic flowchart describing a bonding process; and

FIGS. 23 and 24 schematically illustrate solvent vapour activation in systems using bonding formations.

### DETAILED DESCRIPTION

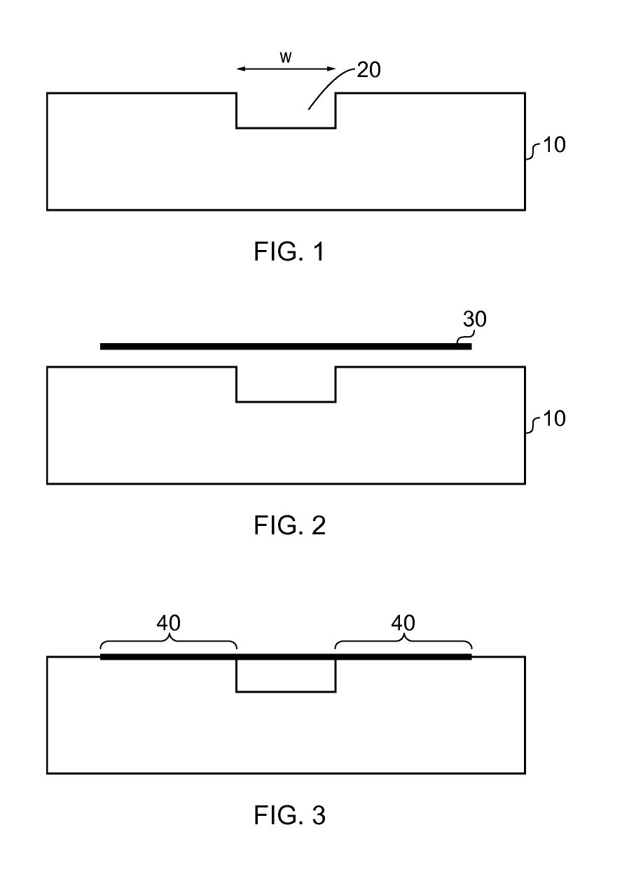

Referring now to the drawings, wherein like reference numerals designate identical or corresponding parts throughout the several views, FIGS. 1 to 3 are provided to illustrate a problem which is addressed by embodiments of the present technique.

FIG. 1 schematically illustrates a substrate 10 of a microfluidic device.

The substrate 10 is formed of a polymer material. In a typical device in which multiple substrates or layers are bonded together, the polymer materials for the different layers may be the same or different, though in embodiments of the present disclosure the two materials are of the same “class” such as COP or similar “class” such as COP and COC (defined below). In embodiments of the disclosure, the two materials used for a pair of bonded layers are identical.

Suitable base polymers for the substrate 10 include: polystyrene (PS), polyethylene (PE), cycloolefin polymer (COP), cycloolefin co-polymer (COC), styrene-acrylonitrile copolymer (SAN), polyamide (nylon), polycarbonate (PC), and polymethyl methacrylate (PMMA). Specific example plastics compounds are as follows. PS: BASF ‘158K’ which is a high heat, clear material suitable for injection moulding; COP: Zeon Chemicals ‘Zeonor 1060R’ which is a clear, low water absorption material suitable for injection moulding; PMMA: Asahi Kasei ‘Delpet 70NH’ which is transparent and suitable for injection moulding; and HM671T ‘PC Bayer MaterialScience AG ‘Makrolon 2458’ which is a medical grade, clear material suitable for injection moulding.

The bonding process may be thermal bonding, in which case the softening is by heating. Alternatively, the process may be solvent vapour bonding, wherein softening is caused by exposure of one or both of the surfaces to a solvent vapour. Both are examples of bonding by surface deformation. Of course, solvent vapour bonding may also be associated with some heating (for example, to an elevated temperature which is below the glass transition temperature Tg of the material). There are also other softening techniques which may be used, instead of or in addition to the techniques already described. These include one or more of: plasma activation, ultraviolet activation, liquid solvent activation. All of these techniques can be considered to serve the same purpose: softening at least the surface of the material (possibly to a depth of just a few pm), for example by reducing the glass transition temperature Tg of the material. Other methods of softening may also (or instead) be used.

An open formation 20 is provided in one surface of the substrate 10. The open formation may be, for example, a microfluidic channel, a well, or another microfluidic feature. Note that FIG. 1 schematically illustrates a cross-section of the substrate, so the open formation 20 may extend in a direction perpendicular to the plane of the drawing page.

In an example microfluidic device, the width w of the open formation 20 might be between (say) 10 μm and 1 mm. The length (in a direction perpendicular to the plane of the page) depends upon the nature of the open formation.

The open formation may be formed by, for example, injection moulding, hot embossing or mechanical or laser machining.

Here, the term “open” signifies a hole formed in the surface of a substrate. The hole may have a uniform or a stepped or otherwise varying depth. In some embodiments, the open formations are blind holes, which is to say they are not through-holes to the other side of the substrate. In other embodiments a pit could be formed as a through-hole which is made blind by the bonding of a substrate to the other end of the hole.

In order to provide a closed channel or other closed formation, a further layer such as a foil (a thin, initially flexible layer of polymer or other material, for example between (say) 50 μm and 300 μm thick) or a further substrate of polymer or other material is bonded to the upper surface (as illustrated) of the substrate 10. In this way, the further layer acts as a closure member.

Note that the terms “upper” and “lower”, and other directional terms, are used here merely to provide a clear reference to the diagrams including FIG. 1. The skilled person will understand that they do not imply or require any particular orientation of the assembled device in manufacture or in use.

FIG. 2 schematically illustrates the substrate 10 and such a closure member 30 before being bonded into place, and FIG. 3 schematically illustrates the substrate 10 with the closure member 30 bonded in place.

The bonding techniques will be discussed further below, but in general terms thermal bonding, solvent bonding or solvent activated thermal bonding are example techniques. The actual bonding takes place at peripheral regions 40 around the open formation 20. At these peripheral regions, in an ideal case the surfaces at which bonding is to take place are flat, in order to obtain an even bond. This applies to the power of bonding surfaces (which is to say, the upper surface of the substrate 10 and the lower surface of the closure member 30 as drawn), although in the case of a closure member 30 formed as a foil, the closure member 30 may be sufficiently flexible that the concept of a “flat” surface of the closure member 30 is not applicable. Deviations from flatness of a substrate can be caused by moulding or formation errors (leading to waviness or unevenness of the surfaces) of burrs (raised edges formed around areas which have been moulded or machined). If such deviations are present, they can interfere with the bonding process because bonding will tend to take place at the high points of an irregular surface, leaving week or no bonding at the lower points of the irregular surface. Therefore, these deviations can interfere with the integrity of the finished article, and in particular can affect the integrity of the closed structure formed of the open formation 20 and the closure 30—and in some cases, can cause the closed structure to leak.

Note that the term “flat” encompasses a situation in which the surface in question is flat or substantially flat apart from the formations (such as fluid carrying and/or bonding formations) provided in that surface. In other words, the presence of such deliberately-included formations does not detract from the surface being considered “flat”.

The need to address this potential problem can affect the design of the microfluidic device. In one example, the amount of space devoted to the peripheral regions 40 may need to be large in order to provide a reliable bond and so a reliable seal by the closure member 30 of the open formation 20.

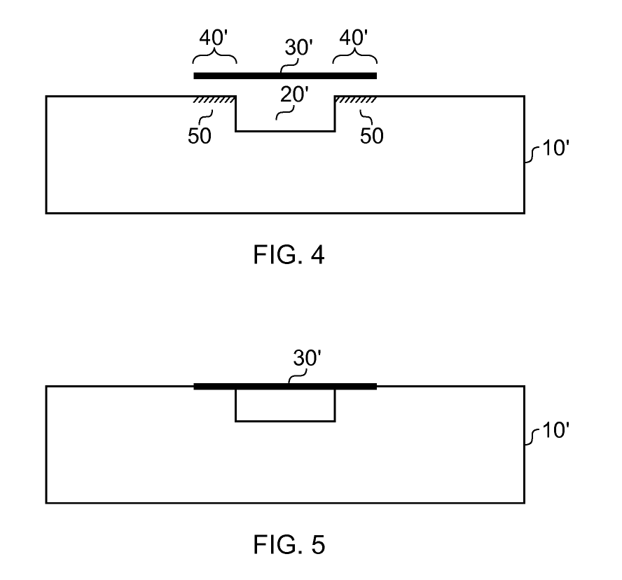

In embodiments of the present technique, additional structural features, to be referred to as bonding formations, are provided in the peripheral regions 40. FIG. 4 schematically illustrates a substrate 10′ of a microfluidic device having such bonding formations 50 formed around an open formation 20′ which is to be covered by a closure member 30′.

The nature of the bonding formations 50 will be discussed in more detail below. For now, it is sufficient to indicate that the bonding formations 50 can assist in providing a more reliable bond, and in turn this can allow the extent of the peripheral regions 40′ to be smaller than that of the corresponding peripheral regions 40 in FIG. 3.

FIG. 5 schematically illustrates the substrate of FIG. 4 with the closure member 30′ bonded in place.

The potential reduction in size required for the peripheral regions, while still allowing for a reliable bond and closure to be formed, can have the effect of allowing a greater density of microfluidic formations at the surface of the substrate.

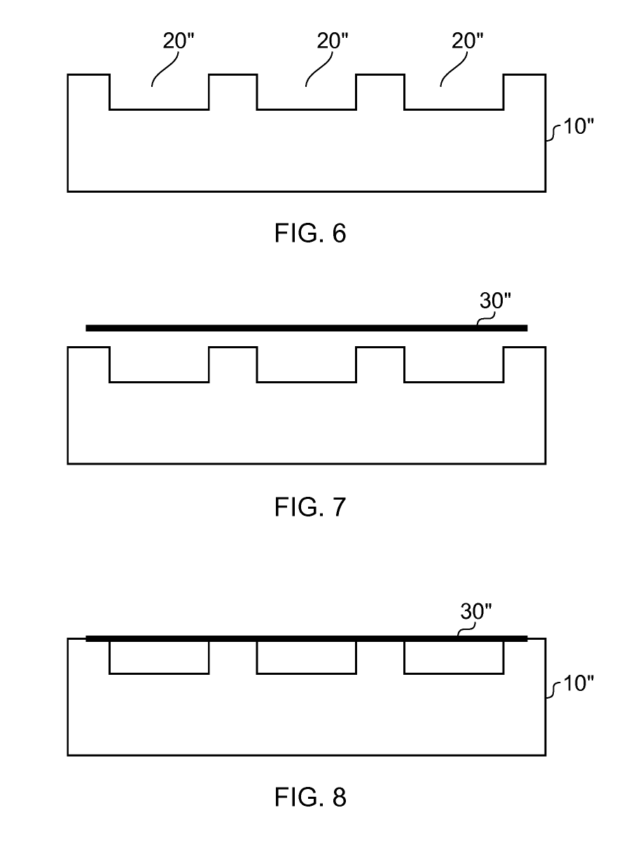

FIGS. 6 to 8 schematically illustrated the closure of a substrate 10″ having plural open formations 20″, which can be closed by a common closure member 30″, as shown in FIGS. 7 and 8, by respect of individual closure members or by shared closure members. A significant feature of FIGS. 6-8 is the shorter distance between the microfluidic formations, made possible because of a more reliable bonding technique between the substrate 10″and the closure member(s) 30″.

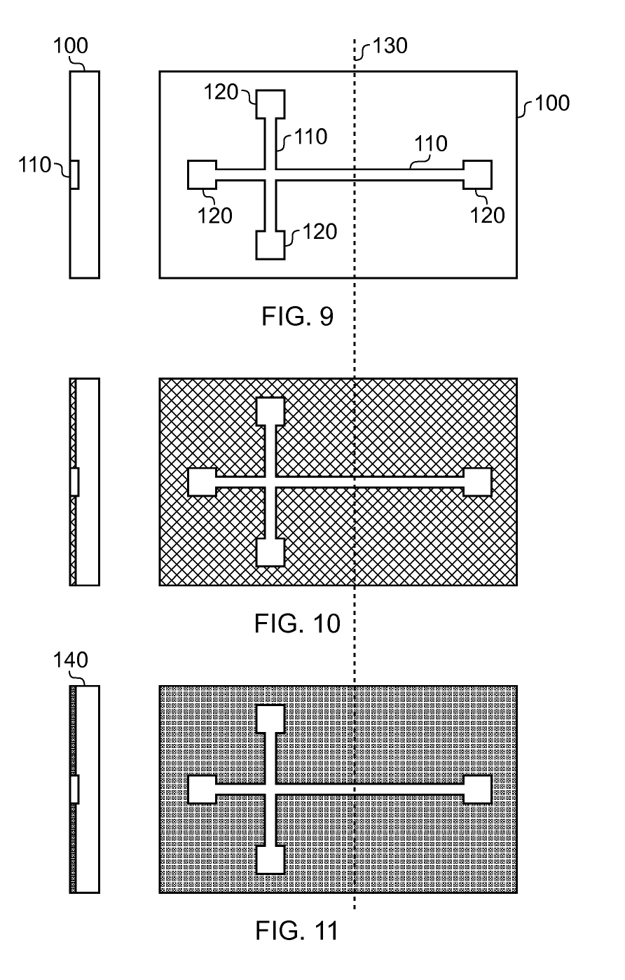

FIGS. 9 to 13 schematically illustrate different forms of bonding formation.

The bonding formations aim to introduce additional structures into the bonding surfaces surrounding the functional structures which can help to achieve one or more of the following:

hide surface defects;

reduce the “active” bonding surface;

increase the activation surface for solvent vapour activation;

improve the sealing around the functional structures;

improve the sealing of electrodes;

reduce the sagging of functional structures like channels;

speed-up the bonding process; and/or

speed-up the activation process (because the activation surface is enlarged).

In example configurations there are open formations (such as channels or wells) which are surrounded by a structured area which may consist/comprise additional structures such as grids/raster structures, pillars, wells, grooves or the like featuring a certain height and “line width”. The height and the line width may be constant or varying across the surface.

In another version only a part of the “surrounding area” is structured in this way.

Another version may include a continuous or part-continuous bonding rim (for example, the width and height of this rim may be (say) 50 μm and 5 μm at the circumference or outer edge of the functional structures. At least a part of the remaining area around the bonding rim area may be structured according to the present techniques.

These structures can be added to functional structures during the preparation of the moulding/embossing/imprinting tools. Such tools are made, for example, of metals, glass, silicon or polymers. Methods to create these structures are (for example) mask lithography, e-beam lithography, laser lithography, laser machining, etching, milling and the like. The structure of the tools are then “transferred/copied” to the polymer parts by (for example) injection moulding, hot embossing, imprinting and the like.

Due to the shrinkage of the polymer material (when the material cools down after moulding) burrs are created even if there is a draft angle. The height of such burrs depend e.g. the height of the structures, the draft angle of the structures, the precision of the moulding tool, the processing conditions and on the shrinkage of the polymer material.

FIG. 9 in fact illustrates a cross-sectional view and a plan view of a simplified microfluidic substrate having to interconnecting channels 110 and multiple microfluidic wells 120. To the left of FIG. 9 there is a cross sectional view drawn with respect to an axis indicated by a dotted line 130. The arrangement of FIG. 9 does not include any bonding formations, but is provided in order that the differences in FIGS. 10-13 can be better explained.

FIGS. 10 and 11 show, schematically, examples of patterning of the remainder of the substrate surface, which is to say all of the substrate surface apart from that portion which has been removed in order to form the microfluidic features 110, 120. In FIG. 10, the patterning is in the form of a grid, so that sets of parallel lines, the sets intersecting one another at an angle such as 90°, are formed in the substrate surface. The lines might be for example 10 μm wide and 3 μm deep, and the distance between the lines might be for example 30 μm. In FIG. 11, once again, sets of parallel lines, the sets intersecting one another at 90°, are formed, but in this case the lines are somewhat wider and deeper (for example 50 μm wide and 10 μm deep) so as to form an array of upstanding formations 140 referred to as “pillars” in the surface of the substrate. Each pillar might be, for example, 10 μm×10 μm×10 μm deep, and the gap between adjacent pillars might be, for example, 50 μm.

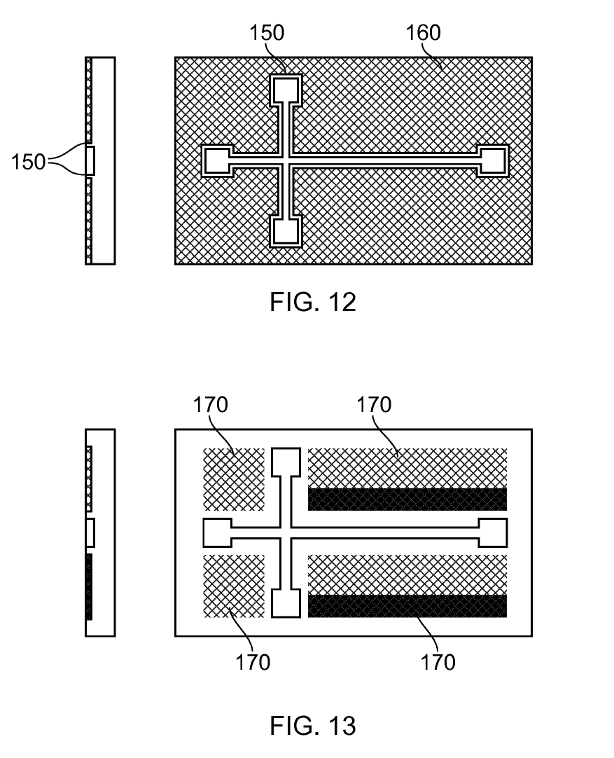

FIG. 12 schematically illustrates another variation of bonding formations, in which a continuous bonding rim 150, for example 50 μm wide, is formed around the open formations, and the rest of the substrate surface is patterned or formed into a set of pillar formations 160 as discussed above. The width, depth and distance (separation) parameters can be different for different regions on a chip or substrate.

In a further variation, in FIG. 13, only certain regions 170 of the substrate surface have bonding formations applied to them.

In general, the patterning of bonding formation microstructures may be arranged adjacent to the fluid-carrying formations, and/or spaced apart from the fluid-carrying formations. The bonding formation microstructures may comprise a grid of indentations or elevations over a region of the substrate surface. The bonding formation microstructures may comprise a bonding rim around a fluid-carrying formation. The substrates may be flat. A second substrate, to be bonded to a patterned substrate, may be formed of a foil material.

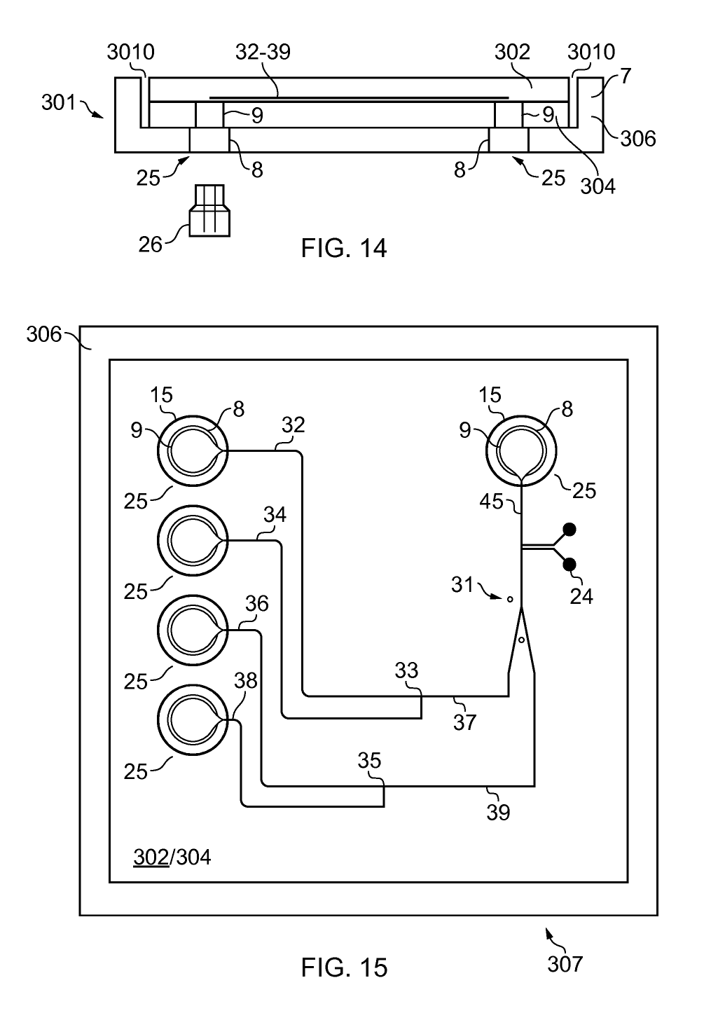

FIG. 14 is a schematic cross-section of an example microfluidic device 301, and FIG. 15 is a schematic plan view of the microfluidic device of FIG. 14.

The device of FIGS. 14 and 15 receives input fluids via (in this example) so-called Luer connectors (more specifically, the example provided is a so-called Luer-slip connector), and provides an output fluid after various fluid processing actions have been performed, again by means of a Luer connector.

The choice of processing actions to be carried out by the device is a decision for the skilled person during a design phase, and is not directly relevant to the present techniques described here. Example processing actions include selective mixing, coalescing, testing, heating, cooling, illumination or other processing actions carried out on the liquids. A subset of these processing actions is illustrated in the example of FIGS. 14 and 15.

Substrate layers 302, 304, 306 are provided, with the substrate layer 306 being shaped so as to form side walls 7 around the device. The substrate layers are bonded together as described above.

A male Luer connector 26 is shaped and dimensioned to engage into a female Luer connector 25 formed by holes 8 and 9. Substrate layers 302, 304, 306 are provided.

The third layer 306 is part of a carrier or caddy accommodating the microfluidic circuit formed by the bonded first and second layers 302 and 304. The carrier has side walls 7 which wrap around the edges of the first and second layers 302 and 304. A thermal expansion gap 3010 may be provided at the lateral edges of the substrate layers 302, 304, where thermal bonding is used between the substrate layer 304 and 306. In other arrangements, the carrier may be implemented using a laser absorbing material, using laser welding to combine the carrier 306 with the substrate layer 304.

A highly schematic microfluidic circuit is depicted, consisting of four female Luer connectors 25 as inlet ports, from which extend channels 32, 34, 36 and 38. Channels 32 and 34 join at a T-shaped droplet generator 33, and channels 36 and 38 join at a T-shaped droplet generator 35, the two merged channels 37 and 39 then in turn combining at a connection-shaped droplet generator 31 into a channel 45. An electrode portion 24 is also shown adjacent the channel 45 and serves, for example, to coalesce droplets of analyte and sample liquid passing along the channel. The channel 45 terminates in an outlet Luer port 25 with laser weld 20. It will be appreciated that in some implementations some of the inlet/outlet ports may be sealed with O-rings (or other gasket types) and others with continuous seam welds.

It will be understood that the bonding of at least the substrate 302 to the substrate 304, by which the holes 9 are closed, may be carried out using techniques as described here. The substrate 302 may be replaced by a different type of closure member such as a foil (for example, a thin, flexible leaf or sheet of material), as discussed above. Bonding of other bonded pairs of substrates, whether or not the bond results in the complete sealing of an open formation, may be carried out using these techniques.

Accordingly, the device of FIG. 14 is an example of a microfluidic device comprising: a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels, in which one or more bonding formation microstructures (see FIGS. 10 to 13, for example), separate to the fluid-carrying formations defining the microfluidic channel network, are formed so as to roughen at least one of the bonding surfaces.

The term “roughen”, when used in connection with a surface having bonding formation microstructures, indicates that the surface under discussion is less smooth, or less uniform, or more rough, with the bonding formation microstructures present than it would have been without their presence.

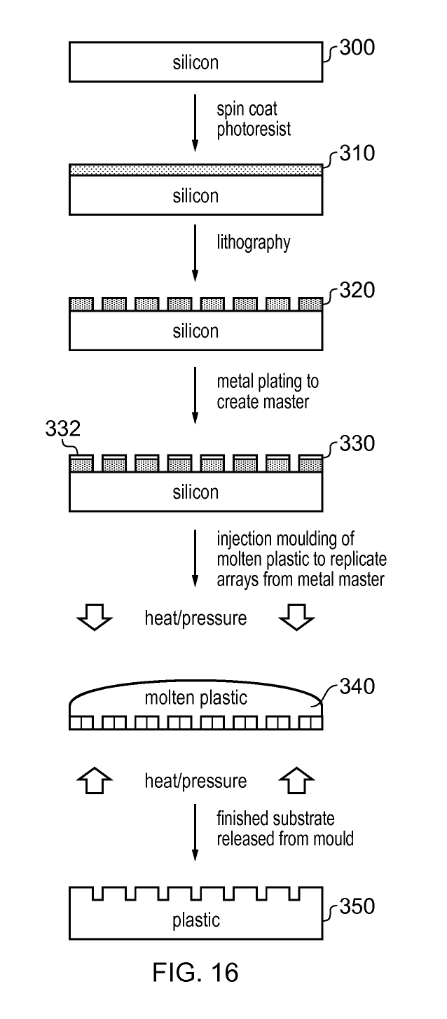

The way in which the various features of the individual substrate layers are formed will now be described with reference to FIG. 16.

FIG. 16 is a schematic flowchart illustrating steps in the production of a substrate using injection moulding. Because the bonding formation microstructures discussed above may be formed as part of the injection moulding process (though note that they could be post-machined or etched into the substrates), FIG. 16 therefore provides an example of a method of manufacturing a microfluidic device, the method comprising: providing a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels; and providing one or more bonding formation microstructures, separate to the fluid-carrying formations defining the microfluidic channel network, are formed so as to roughen at least one of the bonding surfaces.

The first part of the process is to manufacture a master.

A silicon or glass wafer 300 is spin coated with a photoresist 310. A laser or other suitable light source is then used to expose the photoresist to define a structure with high spatial resolution. The material to be exposed is transparent to the laser light used. However, in the focal volume of this highly focused laser beam a chemical or physical modification is created. Ultimately a selective solubility of the exposed area relative to the surrounding is achieved. In a developer bath, depending on the photosensitive material which is used, either the exposed or unexposed areas are removed. In other words, if the photoresist is such that exposure to the laser light leaves or renders it insoluble, and leaves or renders the unexposed material soluble, then the unexposed material is removed in the developer bath. For other photoresist materials the opposite could apply so that the developer bath removes the exposed material. Thus, almost any “2.5D” structures from a variety of photosensitive materials can be realized (for example SU-8 or the positive photoresist AZ9260 from AZ Electronic Materials are examples of suitable types of photoresist). Note that the expression “2.5D” is notation to indicate a three-dimensional structure which is limited by the fact that undercut formations cannot be implemented by this technique, but embodiments are also applicable to 3D structures more generally.

Alternative technologies for structuring the resist master are direct laser micromachining, e-beam lithography or mask based lithography processes. Laser write lithography can also be used with inorganic phase transition materials instead of the photoresist pushing the size resolution limit below the wavelength of the laser. Further details of applicable processes can be found in JP4274251 B2 (equivalent to US2008231940A1) and JP 2625885 B2 (no English language equivalent). Further background documents relating to the fabrication process for microfluidic devices include: Bissacco et al, “Precision manufacturing methods of inserts for injection moulding of microfluidic systems”, ASPE Spring Topical Meeting on Precision Macro/Nano Scale Polymer Based Component & Device Fabrication. ASME, 2005; Attia et al, “Micro-injection moulding of polymer microfluidic devices”, Microfluidics and Nanofluidics, vol. 7, no. 1, July 2009, pages 1-28; and Tsao et al, “Bonding of thermoplastic polymer microfluidics”, Microfluidics and Nanofluidics, 2009, 6:1-16. All of these documents are hereby incorporated by reference.

Once the photoresist has been suitably structured and the exposed (or non-exposed, as the case may be) material removed to form a structured photoresist 320, a metal plating processing step is applied. Electroplating is used to deposit a nickel layer by electrolysis of nickel salt-containing aqueous solutions, so-called nickel electrolytes. Nickel electrolytes usually have nickel or nickel pellets as the anode. They serve the supply of metal ions. The process for the deposition of nickel has long been known and been highly optimized. Most nickel electrolytes achieve an efficiency of >98%, which means that over 98% of the current supplied to be used for metal deposition. The remaining power is lost in unwanted electrolytic processes, such as hydrogen. The transcription of lithographically structured micro-features is strongly dependent on compliance with the correct parameters. Not only the continuous supply of additives, but also the metal ion content, the temperature and the pH value need to be maintained.

The result is a metal coated version 330 (having a metal coating 332) of the structure defined by the partially removed photoresist.

Direct milling into steel can be used as an alternative to silicon and photoresist in order to master such microstructures. Other methods, or other variations on the methods described above, are also possible, as described in the documents referenced below.

Basically a moulding tool called a mould or die consists of two halves/plates. At the parting surface a cavity defines the shape of the final polymer part. The cavity may reach into only one plate or into both plates. For injection moulding of microfluidic polymer parts so called masters created by various technologies are used within the plates to define the microstructures. The steps 300 to 330 refer to the formation of one of those masters, which in the present example is a master which carries microstructures arranged so as to define complementary microstructures on the moulded part. The polymer melt enters the cavity through a gate at the end of a sprue or runner system in the mould.

The master is then used in an injection moulding process to create the structured surfaces in polymer to incorporate the structuring needed for the microfluidic channel network.

During an injection moulding cycle usually the injection mould can be kept at a certain mould temperature (referred to as isothermal moulding). For other special applications, the temperature of the mould or only the surfaces of the cavity and/or the master can instead be varied during the moulding cycle for instance to improve the replication of the structures (variothermal moulding).

After closing the mould the polymer melt is injected into the cavity at a high temperature, high pressure and high speed. For instance for COP 1060R which has a glass transition temperature Tg of about 100° C. the mould temperature which defines the temperature of the walls of the cavity is usually about 70° C. to 95° C., the injection temperature is about 210° C., the injection pressure is about 500-1500 kgf/cm² and the injection speed is about 30-80cm³/s.

After filling of the cavity a holding pressure is applied with the aim to compensate for the material shrinkage at the expense of freezing residual stress. The material solidifies into the final shape as the material temperature decreases below the glass transition temperature of the material by cooling of the mould. The mould can be opened and the polymer part can be de-moulded and ejected/removed from the mould (including the microstructures). Then the injection cycle can be repeated.

As discussed, in an injection moulding machine, polymers (shown generically as molten plastic 340 in FIG. 6) are plasticized in an injection unit and injected into a mould. The cavity of the mould determines the shape and surface texture of the finished part. The polymer materials need to be treated carefully to prevent oxidation or decomposition as a result of heat or sheer stresses. Heat and pressure are applied to press molten polymer onto the structured surface of the master. Depending on the polymer, the thickness of the part and complexity of the structures the cycle time can be a few seconds (e.g. for isothermal moulding of optical discs) up to several minutes (for example for variothermal moulding of thick parts with high aspect ratio microstructures). After a suitable filling, cooling and hardening time (noting that cooling and hardening take place together for thermoplastics), the heat and pressure are removed and the finished plastics structure 350 is ejected from the mould. The injection moulding process can then be repeated using the same master.

The cost of the master and the larger moulding tool represents a large part of the total necessary investment, so the process lends itself to high volumes. Simple tools enable economic viable prototyping from a threshold of a few thousand parts. Tools for production can be used up to make up to several million parts.

The injection moulded substrate can be further plasma treated to control the surfaces properties, for example to alter the glass transition temperature Tg or to change the surface tension (or contact angle, respectively).

Moreover, a coating can be applied to a whole surface or selectively applied to only some areas as desired. For example, sputtering, ink jet printing, spotting or aerosol jetting may be used to deposit a coating.

Finally, it is noted that the carrier may not include features requiring precision on the same small size scale as the layers which are used to form the planar microfluidic circuit elements. It will therefore be possible in some cases to manufacture the carrier using simpler or alternative methods.

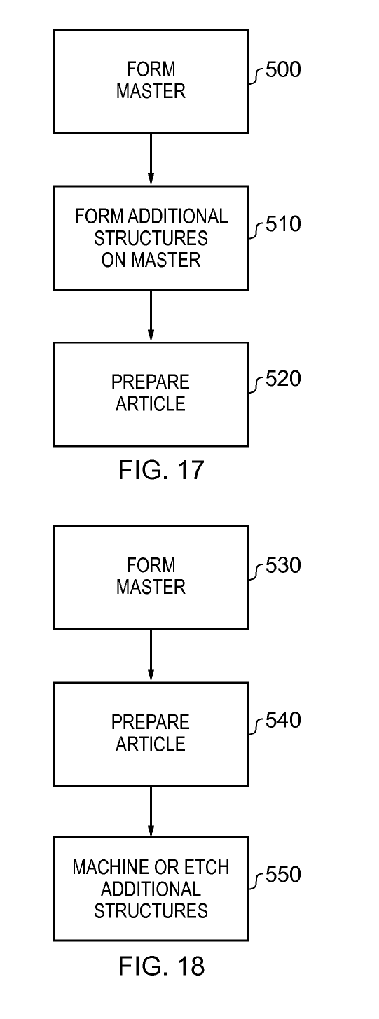

FIGS. 17 and 18 are respective alternative flowcharts showing steps in the production of bonding formations on a substrate. In basic terms, the two alternative techniques involve either generating the bonding formations as part of producing the master (in the steps 300 . . . 330 discussed above) or mastering and preparing the substrate, followed by forming the bonding formations on the already moulded substrate.

In more detail, in FIG. 17, at a step 508 suitable master is prepared as discussed above. A step 510 (shown as a separate step for clarity of the explanation, but which could take place during the step 500) involves forming additional structures on the master, as a negative formation so as to produce the required bonding formations. Then, at a step 520, the substrate is prepared, for example, by injection moulding from the master using the various techniques discussed above.

As the alternative to FIG. 17, the master is formed at a step 530, then at a step 540 the substrate is prepared, for example by injection moulding. Then, at a step 550, the bonding formations are machined or etched as additional structures on the prepared substrate.

One technique for bonding substrates and other parts (other substrates, closure members, foils and the like) together is referred to as solvent activated thermal bonding. Here, the surface of a substrate to be bonded is treated with a solvent, typically in vapour form, to alter the surface properties of the substrate. In particular, the application of the solvent can have the effect of reducing the so-called glass transition temperature Tg at the substrate surface, which allows thermal bonding to take place at temperatures below the original value of Tg.

It has been found from investigations of the solvent vapour activation process that the solvent diffuses into the polymer material. The “diffusion” depth is dependent on parameters such as polymer material, type of solvent, solvent vapour concentration and exposure time. By this solvent vapour activation process the Tg (glass transition temperature) is reduced which allows the process to execute a bond at temperatures below Tg. By adapting the structure width and depth it can be possible to adjust the “activation depth” and thus increase the process window (which is to say, reduce the influence on the success or outcome of the bonding process of parameters such as activation parameters, temperature, pressure, pressure distribution and timing. In embodiments of the present technique, the bonding formations can themselves be used to tune the pressure distribution during bonding, so as to minimize or at least partially avoid the deformation of (for example) the channels/wells during bonding.

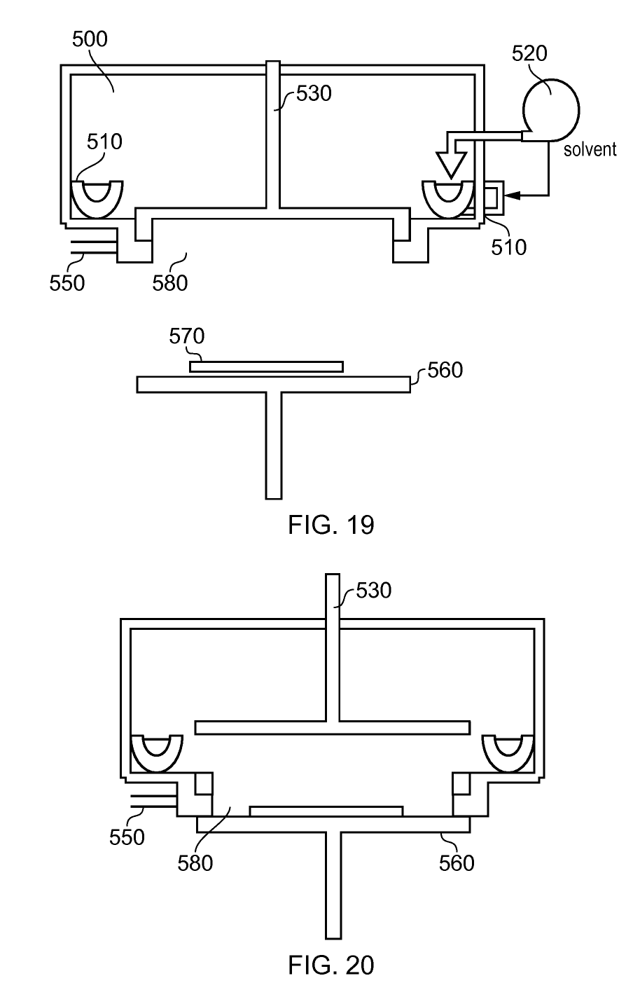

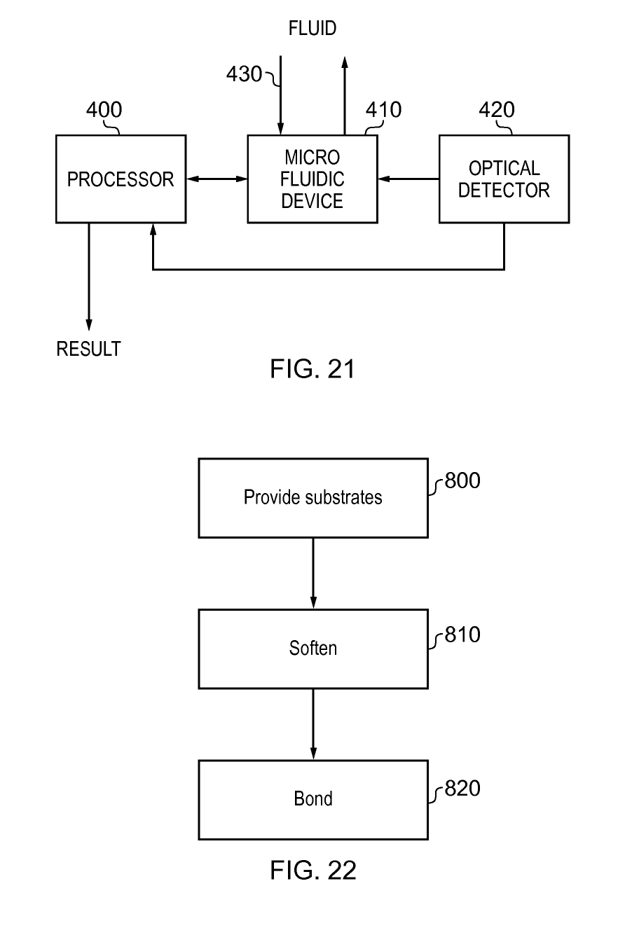

FIG. 19 schematically illustrates an apparatus for solvent activation, and FIG. 20 schematically illustrates the apparatus of FIG. 19 in use. A solvent activated thermal bonding process will be discussed in connection with these two Figures.

Referring to FIG. 19, the apparatus comprises a vapour chamber 500 having solvent receptacles 510 which are selectively supplied with solvent from a solvent reservoir 520, a first movable shutter 530, an exhaust channel 550 and a second shutter and substrate holder 560 on which a substrate 570 is illustrated. Note that, as drawn, it is the upper surface of the substrate 570 which will be subjected to a bonding process.

The first shutter 530 is shown, in FIG. 19, in a closed position such that the shutter has been lowered (as drawn) to seal the vapour chamber 500 against the activation chamber 580. The second shutter and substrate holder 560 is also shown in a pre-deployment position below the main part of the apparatus.

A space 580 below the first movable shutter 530 forms an activation chamber when sealed by the second shutter and substrate holder 560. This feature will be shown in more detail in the FIG. 20.

A first stage of the process is to dispense solvent into the solvent receptacles 510. Examples of suitable solvents include acetone, aniline or phenylamine, butanol or butyl alcohol, butanone or methyl ethyl ketone, chloroform, cyclohexane, diacetone alcohol, dibutyl ether, dichloromethane or methylene chloride, diethyl ether or ethyl ether, dimethylformamide, dioxane, ethyl acetate, isopropanol or isopropyl alcohol, methanol or methyl alcohol, tetrafluoropropene, toluene, trifluoroethanol or trifluoroethyl alcohol, xylene, phenol or carbolic acid and formic acid, or mixtures of the above liquids.

In embodiments of the present technology, the solvents used are cyclohexane and chloroform. These solvents are appropriate for the COC and COP polymers discussed above.

Because the receptacles 510 are open, the solvent evaporates and, over a moderate period of time, fills the chamber 500 above the first shutter. Once this has happened, the second shutter and substrate holder 560 is raised, as shown in FIG. 20, so as to close the activation chamber 580. Once this is closed, the first shutter 530 is opened by being raised. This allows the solvent vapour to pass into the activation chamber. After a time period for the solvent vapour to diffuse into the activation chamber the first shutter 530 is lowered again so as to close off the activation chamber 580. This shuts off the supply of solvent vapour to the activation chamber. A second time period is then allowed to provide for the solvent vapour in the activation chamber 580 to act appropriately on the surface of the substrate 570.

After this second predetermined time, the activation chamber is flushed with nitrogen gas and the remaining solvent vapour is removed through the exhaust port 550. The unused solvent can be reclaimed for reuse. In this way, the solvent vapour in the activation chamber is entirely replaced by nitrogen gas. Once this has happened, the second shutter is opened (lowered) and the processed substrate 570 is removed for thermal bonding. If required, further solvent may be added to the solvent receptacles 510.

The net solvent consumption can be very low because of the reclamation of the solvent. For one experimental product (2 plates, chip size about 70 mm×70 mm×1.5 mm each) the solvent consumption was about 10 μg/chip.

The activation time (the second predetermined time) is depending on at least the polymer material (e.g. the glass transition temperature), the solvent used and the temperature.

The time between activation and thermal bonding should be as short as possible to benefit from the solvent activation, preferably less than 30 sec. Immediately after activation the surface is “sticky” because of the presence of solvent in the top layers or regions of the substrate. After 30 sec-60 sec the surface is not sticky but solvent will remain in the substrate up to a depth of a few μm with a concentration peak at a depth of about 2-3 μm for a significant time. During thermal bonding this solvent will move to the bonding plane and activates the surface, again. After bonding usually there is an annealing step at elevated temperature to reduce the stress (introduced by bonding) and to remove the solvent from the non-bonded areas.

By this solvent vapour activation the glass transition temperature is reduced by 20° C.-30° C. only at the near-surface layers or regions (within a few μm of the surface). Therefore the bonding temperature can be reduced by 20° C.-30° C. and the structure deformation (channels, wells, etc.) can be reduced

In embodiments of the present techniques, it is noted that the solvent vapour diffuses into the polymer material of the substrate 570 to a certain depth, referred to as the “diffusion depth”, with the diffusion depth being dependent upon parameters such as polymer material, type of solvent, the solvent vapour concentration and the exposure time (the second predetermined time discussed above). The effect which the solvent process has on Tg depends in part upon the diffusion depth. According to embodiments of the present technique, it has been found that the diffusion depth in turn can depend upon the nature of the bonding formations discussed above, so that the bonding formations can improve the efficiency of a solvent activated thermal bonding process.

In experiments using solvent vapour treatment of a COP material, the Tg of the COP material was reduced by the solvent from about 100° C. to about 80° C. If the chip is heated to a temperature of 80° C. the material will become soft and viscous only in the solvent vapour treated region—so only the first few micrometres of the surface. The other material will stay hard. By adjusting the width, depth and distance of bonding formations discussed above it is possible to adjust how much material (volume) will become soft. This can be adjusted individually for different areas of the chip.

For example if a diffusion depth of about 10 μm, a solvent concentration peak of about 3 μm and a bonding formation width of about 10 μm are assumed, the Tg of the bonding formation and the first 3 μm of the area between the structures will be 80° C. while the Tg of the other chip material will remain at 100° C.

By adjusting the height and distance of the bonding formations it is possible to define how much material/volume will be treated (will become soft) if the chip is heated to 80° C.

If the height and the distance of the bonding formations is adjusted to 10 μm the solvent activated volume is increased by a factor of about 2.7 compared to a non-structured area.

If the height of the bonding formations is adjusted to 2 μm and the distance of the bonding formations is adjusted to 10 μm the solvent activated volume is increased by a factor of about 1.3 compared to a non-structured area.

Currently for injection moulding there is a technical limitation for the aspect ratio of such bonding formations of about 5 (height 50 μm, width 10 μm).

If the height of the bonding formations is adjusted to 50 μm and the distance of the bonding formations is adjusted to 10 μm the solvent activated volume is increased by a factor of about 9.3 compared to a non-structured area.

So it is possible, in these experiments, to adjust this factor from 1 (not structured) up to about 10 (highly structured).

During bonding part the bonding formations may be deformed partially of completely so that they are not visible after bonding.

For some applications, a microfluidic device is incorporated into an instrument such as a fluid testing instrument. An example instrument is shown schematically in FIG. 12, comprising a processor 400, a microfluidic device 410 as described in the present specification and an optical detector 420. The processor 400 is configured to detect fluid measurement results from the microfluidic device by controlling the microfluidic device and to interpret its output as an output result. The microfluidic device performs a fluid test or detection on an input fluid 430. The (optional) optical detector 420 can assist in this process by detecting the movement of fluids within the microfluidic device.

FIG. 22 is a schematic flowchart describing a bonding process involved in a method of manufacturing a microfluidic device.

A step 800 comprises providing first and second substrates made of respective first and second polymer materials, the first and second substrates having respective bonding surfaces, at least one of the bonding surfaces having open formations so that, when the bonding surfaces are bonded by surface deformation to one another, the bonded first and second substrates and the open formations form at least part of a microfluidic channel network comprising a plurality of microfluidic channels, in which bonding formations, separate to the channel formations defining the microfluidic channel network, are formed in at least one of the bonding surfaces.

A step 810 comprises softening at least one of the bonding surfaces in preparation for bonding to each other. For example, the softening can be heating (in which case thermal bonding is used) or by exposure to a solvent vapour (so that solvent vapour bonding is used), or a combination of the two (in the case of solvent activated thermal bonding).

A step 820 comprises bonding by compression the bonding surfaces of the first and second substrate.

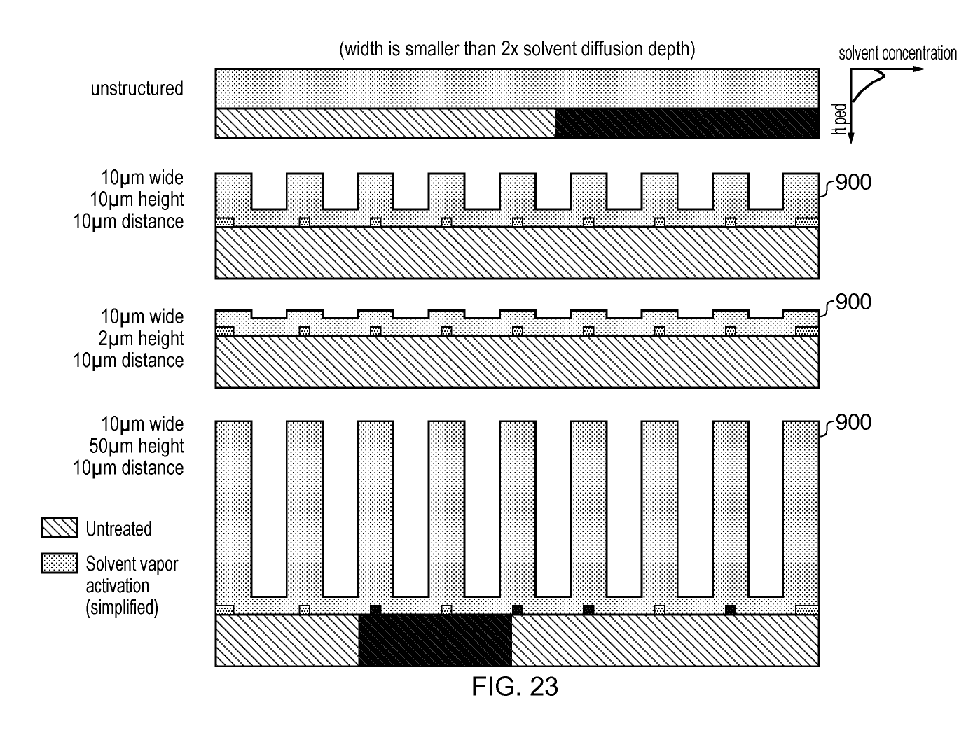

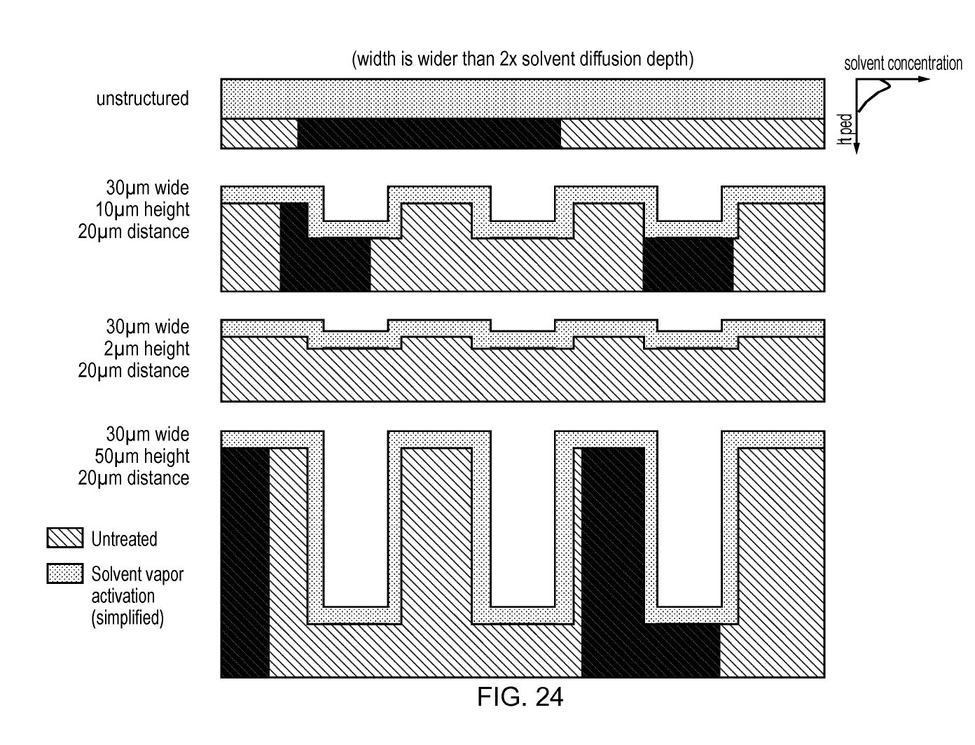

FIGS. 23 and 24 schematically illustrate the effects of solvent vapour activation on substrate surfaces having microstructured bonding formations of one or more of the types described above.

In particular, FIG. 23 relates to structures in which the width of the formations (shown schematically as crenulations 900) is smaller than twice the solvent diffusion depth. FIG. 23 shows four examples of schematic cross-sections through a portion near to the surface of a substrate engaged in a solvent vapour activated bonding process, with each row representing a separate one of the cross-sections: a top row in which no bonding formations are provided; and second to fourth rows with varying heights of bonding formations. The “distance” parameter represents the separation of the crenulations (in the left to right direction of the drawing). The “width” represents the width of an individual one of the crenulated features.

It can be seen that where the bonding formations are provided, a greater effective depth of solvent activation can be achieved. For example, in the lowest row of FIG. 23, more than a 50 μm depth of activation is achieved, which is much greater than in the top (unstructured) row.

FIG. 24 shows a similar arrangement in which the crenulation width is greater than twice the normal solvent diffusion depth. Similarly advantageous results are obtained.

As discussed above, in a technique involving moulding the substrate using a master die, the master die may comprise formations complementary to the bonding formation microstructures, so that the bonding formations are formed on the substrate at the moulding step. Alternatively, or in addition, after moulding, the bonding formation microstructures may be formed on the moulded substrate, for example by a machining process.

An embodiment provides a measurement instrument comprising a microfluidic device as discussed above; and a processor configured to detect fluid measurement results from the microfluidic device.

Various features and at least some embodiments are defined by the following numbered clauses:

1. A microfluidic device comprising:

a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels,

in which one or more bonding formation microstructures, separate to the fluid-carrying formations defining the microfluidic channel network, are formed so as to roughen at least one of the bonding surfaces.

2. The device of clause 1, in which the bonding formation microstructures are arranged adjacent to the fluid-carrying formations.
3. The device of clause 2, in which the bonding formation microstructures are spaced apart from the fluid-carrying formations.
4. The device according to any one of clauses 1 to 3, in which the bonding formation microstructures comprise a grid of indentations over a region of the substrate surface.
5. The device according to any one of clauses 1 to 3, in which the bonding formation microstructures comprise a grid of elevations over a region of the substrate surface.
6. The device according to any one of the preceding clauses, in which the bonding formation microstructures comprise a bonding rim around a fluid-carrying formation.
7. The device of any one of the preceding clauses, in which the substrates are flat.
8. The device of any one of the preceding clauses, in which the second substrate is formed of a foil material.
9. A method of manufacturing a microfluidic device, the method comprising:

providing a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels; and

providing one or more bonding formation microstructures, separate to the fluid-carrying formations defining the microfluidic channel network, are formed so as to roughen at least one of the bonding surfaces.

10. A method according to clause 9, comprising:

moulding the substrate using a master die;

in which the master die comprises formations complementary to the bonding formation microstructures, so that the bonding formations are formed on the substrate at the moulding step.

11. A method according to clause 9, comprising:

moulding the substrate using a master die; and

after the moulding step, forming the bonding formation microstructures on the moulded substrate.

12. A method according to any one of clauses 9 to 11, comprising:

bonding the surfaces by solvent-vapour activated thermal bonding.

13. A measurement instrument comprising:

a microfluidic device according to any one of clauses 1 to 7; and

a processor configured to detect fluid measurement results from the microfluidic device.

Obviously, numerous modifications and variations of the present disclosure are possible in light of the above teachings. It is therefore to be understood that within the scope of the appended clauses, the invention may be practiced otherwise than as specifically described herein.

1. A microfluidic device comprising:
a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels,
in which one or more bonding formation microstructures, separate to the fluid-carrying formations defining the microfluidic channel network, are formed so as to roughen at least one of the bonding surfaces.

2. The device of claim 1, in which the bonding formation microstructures are arranged adjacent to the fluid-carrying formations.

3. The device of claim 2, in which the bonding formation microstructures are spaced apart from the fluid-carrying formations.

4. The device of claim 1, in which the bonding formation microstructures comprise a grid of indentations over a region of the substrate surface.

5. The device of claim 1, in which the bonding formation microstructures comprise a grid of elevations over a region of the substrate surface.

6. The device of claim 1, in which the bonding formation microstructures comprise a bonding rim around a fluid-carrying formation.

7. The device of claim 1, in which the substrates are flat.

8. The device of claim 1, in which the second substrate is formed of a foil material.

9. A method of manufacturing a microfluidic device, the method comprising:
providing a first substrate made of a first polymer material and a second substrate made of a second material, the first and second substrates having respective bonding surfaces, at least one of the bonding surfaces having fluid-carrying formations so that, when the bonding surfaces are bonded by surface deformation to one another, the bonded first and second substrates and the fluid-carrying formations form at least part of a microfluidic channel network comprising a plurality of microfluidic channels; and
providing one or more bonding formation microstructures, separate to the fluid-carrying formations defining the microfluidic channel network, are formed so as to roughen at least one of the bonding surfaces.

10. A method according to claim 9, comprising:
moulding the substrate using a master die;
in which the master die comprises formations complementary to the bonding formation microstructures, so that the bonding formations are formed on the substrate at the moulding step.

11. A method according to claim 9, comprising:
moulding the substrate using a master die; and
after the moulding step, forming the bonding formation microstructures on the moulded substrate.

12. A method according to claim 9, comprising:
bonding the surfaces by solvent-vapour activated thermal bonding.

13. A measurement instrument comprising:
a microfluidic device according to claim 1; and
a processor configured to detect fluid measurement results from the microfluidic device.
